(19) United States
(12) Patent Application Publication
(10) Pub. No.: US 2007/0085988 A1
(43) Pub. Date: Apr. 19, 2007

(54) Wafer edge exposure method in semiconductor photolithographic processes, and orientation flatness detecting system provided with a WEE apparatus

(75) Inventor: Ook Hyun Kim, Bucheon-si (KR)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: DongbuAnam Semiconductor Inc.

(21) Appl. No.: 11/254,296

(22) Filed: Oct. 19, 2005

(51) Int. Cl. G03B 27/42

(52) U.S. Cl. 355/53

(57) ABSTRACT

The present invention relates to a method for exposing an edge of a semiconductor wafer in photolithographic processes, and an OF (Orientation Flatness) detecting system provided with a WEE (Wafer Edge Exposure) apparatus. According to the present invention, a notch-aligned wafer can be treated by a WEE process on a wafer chuck of an OF detecting system, without waiting for its patterning exposure process to be performed first. Thus, the total processing time in photolithographic processes can be decreased.

### BACKGROUND OF THE INVENTION

1. Field of the Invention

The present invention relates to semiconductor photolithographic processes. More specifically, the present invention relates to a method for exposing an edge of a semiconductor wafer in photolithographic processes, and an OF (Orientation Flatness) detecting system provided with a WEE (Wafer Edge Exposure) apparatus.

2. Description of the Related Art

Conventionally, a wafer edge exposure (WEE) process additionally exposes a round edge and ID region of a wafer after exposing the wafer provided with a photoresist in a stepper. In such a wafer edge exposure process, a portion of the photoresist formed on the edge of the wafer is removed. This prevents the portion of the photoresist on the edge from peeling off during photolithographic processes. If the portion of the photoresist peels off, the yield of semiconductor devices from the wafer may decrease.

FIG. 1 shows a series of conventional photolithographic processes. Referring to FIG. 1, a soft baked wafer in step of S100 is carried to an OF (Orientation Flatness) detecting system of a stepper. On the OF detecting system, the notch of the wafer is aligned in a manner known to those skilled in the art (S102). Subsequently, the wafer is moved onto a wafer stage where a wafer EGA alignment S104 is performed. And then, a portion of a photoresist formed on the wafer is exposed in a predetermined pattern by a pattern exposure process S106. When the pattern exposure is finished, the wafer is moved to a WEE apparatus so that a WEE process S108 is performed.

However, in the above conventional photolithographic process, the wafer is generally carried to the WEE apparatus for the WEE process only after the notch-aligned wafer is exposed in the stepper. Therefore, the notch-aligned wafer generally must wait until an exposure process of another, preceding wafer is finished before subsequent processes in the OF detecting system can be conducted.

In other words, in the above conventional photolithographic process, the notch-aligned wafer generally waits for its exposure process without any treatment until the exposure process of the preceding wafer is complete. As a result, a waiting time in the OF detecting system may increase so that the total processing time in the stepper may be unnecessarily long.

### SUMMARY OF THE INVENTION

It is therefore an object of the present invention to provide a method for exposing an edge of a semiconductor wafer in a photolithographic process that enables reduction of the total processing time in photolithographic processing.

Another object of the present invention is to provide an OF detecting system with a WEE apparatus, which can facilitate photolithographic processing according to the present method.

To achieve the above object, an embodiment of a method for exposing an edge of a semiconductor wafer in photolithographic processes according to the present invention comprises the steps of: (a) aligning a notch of a wafer disposed on a wafer chuck of an orientation flatness (OF) detecting system using a wafer notch-detecting sensor; (b) performing a wafer edge exposure (WEE) process on the notch-aligned wafer; (c) carrying the wafer to a wafer stage and then performing a wafer EGA alignment; and (d) exposing the EGA-aligned wafer.

Preferably, the method further includes disposing the wafer on the wafer chuck such that a center of the wafer is aligned with a center of the wafer chuck, and/or detecting the center of the wafer by a wafer center position detecting sensor unit. In addition, in step (c), the WEE process is performed while exposing a preceding wafer.

In addition, an orientation flatness (OF) detecting system according to the present invention comprises: (a) a wafer loader arm able to carry a wafer; (b) a wafer center position detecting sensor unit adapted to detect a center of the wafer; (c) a rotatable wafer chuck on which the wafer is to be disposed; (d) a wafer notch detecting sensor unit adapted to detect a notch of the wafer; and (e) a wafer edge exposure (WEE) apparatus including a WEE unit exposing an edge of the wafer, and a WEE driving unit able to move the WEE unit. Preferably, the WEE driving unit is able to move the WEE unit in a radial direction of the wafer.

These and other aspects of the invention will become evident by reference to the following description of the invention, often referring to the accompanying drawings.

### BRIEF DESCRIPTION OF DRAWINGS

FIG. 1 shows a series of conventional photolithographic process steps.

FIG. 2 is a cross-sectional view of an OF detecting system provided with a WEE apparatus according to an embodiment of the present invention.

FIG. 3 shows a series of photolithographic process steps using the OF detecting system provided with a WEE apparatus according to the present invention.

### DETAILED DESCRIPTION OF THE INVENTION

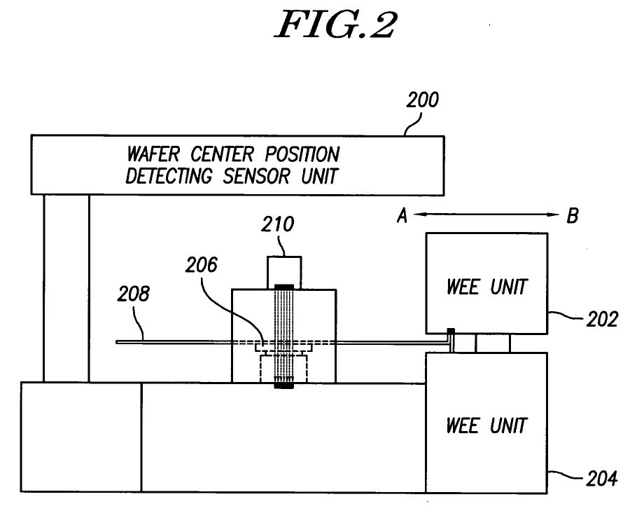

FIG. 2 shows a cross-sectional view of an OF detecting system further including a WEE apparatus according to an embodiment of the present invention. Referring to FIG. 2, the OF (Orientation Flatness) detecting system comprises a wafer notch detecting sensor unit 210 adapted (or configured) to detect a notch of a wafer 208, a wafer center position detecting sensor unit 200 adapted (or configured) to detect the center of the wafer 208, a WEE (Wafer Edge Exposure) unit 202 adapted (or configured) to perform a WEE process, a WEE driving unit 204 adapted (or configured) to change a position of the WEE unit 202, and a wafer chuck 206.

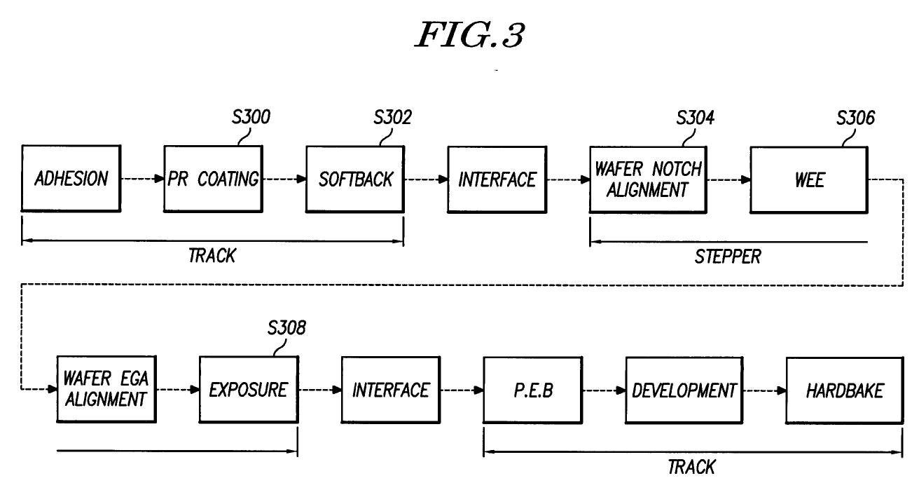

FIG. 3 shows a series of photolithographic processes using the OF detecting system provided with a WEE apparatus according to the present invention. Hereinafter, the preferred embodiment of the present invention will be explained in detail with reference to FIGS. 2 and 3.

First, after the wafer 208 is coated with a photoresist and soft baked in a track facility or section of a photolithographic apparatus (i.e., after completion of processes of S300 and S302), the wafer 208 is moved to a predetermined wafer-loading position of a stepper through an interface device. Then, the wafer 208 is disposed (or placed) on the wafer chuck 206 by a wafer loader arm. Here, the center of the wafer 208 is detected conventionally by the wafer center position detecting sensor unit 200, which is provided on the wafer loader arm. When the center of the wafer 208 is detected, the wafer loader arm puts the wafer 208 on the wafer chuck 206, aligning the center of the wafer 208 with the center of the wafer chuck 206 according to conventional technology.

After the wafer 208 is positioned on the wafer chuck 206, the wafer 208 is rotated, and simultaneously, the notch of the wafer 208 is detected by a wafer notch detecting sensor 210. After the notch of the wafer 208 is aligned (S304) with a predetermined alignment reference or at a predetermined location in accordance with conventional wafer alignment technology, the wafer 208 does not wait for an exposure process S308 of a preceding wafer (which has been treated ahead of the wafer 208) to finish. Instead, a WEE process is preferably performed on the wafer 208 right after the wafer notch alignment S304. Here, in the WEE process S306, a predetermined edge area (or so-called “bead” area) of the wafer 208 of less than 5 mm, 3 mm or 2 mm (as the case may be) along the outermost part of the radius of wafer 208 is exposed to radiation conventionally used for edge exposure in photolithography according to a pre-set recipe. Preferably, the WEE unit 202 can be moved radially (i.e., A⇄B, in a radial direction of the wafer 208) by the WEE driving unit 204, thereby enabling control of the exposed area.

In the meantime, because the WEE apparatus needs to recognize, detect and or align the notch of the wafer 208, the WEE process is preferably performed right after the wafer notch alignment S304. When the exposure process of the preceding wafer is finished, then the wafer 208 is moved from wafer chuck 206 to a wafer stage, and the wafer 208 is exposed (generally according to a conventional exposure process S308).

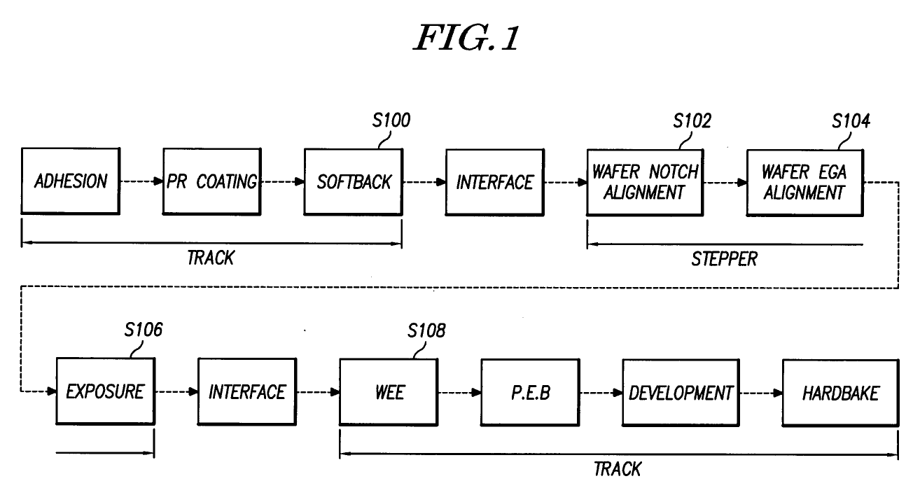

As explained, in the conventional method, a notch-aligned wafer generally waits for its conventional exposure process (e.g., patterning) without any treatment until the corresponding exposure process (e.g., patterning) of a preceding wafer is finished. As a result, the processing time necessary for a WEE process may be unduly long. However, according to the present invention, a notch-aligned wafer may have its edge area exposed to radiation (e.g., undergo a WEE process) on the wafer chuck of the OF detecting system while waiting for its turn in the patterning exposure process. Thus, the total processing time in photolithographic processes can be decreased relative to the conventional process outlined in FIG. 1.

Although the WEE processing time of the first wafer may be the same as a conventional processing time, the WEE processing time of successive wafers (i.e., from the second wafer on) in a given batch or lot can be decreased. As a result, the total processing time in the photolithographic process per batch or lot of wafers can be decreased.

For example, as shown in FIG. 3, after a preceding wafer (i.e., the first wafer) is notch-aligned and edge-exposed in a WEE process, the preceding wafer is set on a wafer stage, EGA aligned, and exposed in S308 to form photolithographic patterns in the photoresist previously coated on the wafer. During a time (around 1 minute) from the EGA alignment to the exposure of the preceding wafer, a following wafer (e.g., the second wafer) undergoes notch alignment and a WEE process in the present OF detecting system.

According to the present invention as described above, a notch-aligned wafer can be treated by a WEE process on a wafer chuck of an OF detecting system, without waiting for its exposure process for photolithographic patterning to be completed first. Thus, the total processing time in photolithographic processes can be decreased.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for exposing an edge of a wafer in a photolithographic process, comprising the steps of:
(a) aligning a notch of the wafer disposed on a wafer chuck of an orientation flatness (OF) detecting system using a wafer notch-detecting sensor;
(b) performing a wafer edge exposure (WEE) process on the notch-aligned wafer;
(c) carrying the wafer to a wafer stage and then performing a wafer EGA alignment; and
(d) exposing the EGA aligned wafer.

2. The method of claim 1, further comprising disposing the wafer on the wafer chuck such that a center of the wafer is aligned with a center of the wafer chuck.

3. The method of claim 1, wherein step (a) comprises detecting the center of the wafer by a wafer center position detecting sensor unit, before disposing the wafer on the wafer chuck.

4. The method of claim 1, wherein step (c) is performed while exposing a preceding wafer.

5. An orientation flatness (OF) detecting system, comprising:
(a) a wafer loader arm able to carry a wafer;
(b) a wafer center position detecting sensor unit adapted to detect a center of the wafer;
(c) a rotatable wafer chuck on which the wafer is to be disposed;
(d) a wafer notch detecting sensor unit adapted to detect a notch of the wafer; and
(e) a wafer edge exposure (WEE) apparatus including a WEE unit adapted to expose an edge of the wafer disposed on the wafer chuck, and a WEE driving unit able to move the WEE unit.

6. The OF detecting system of claim 4, wherein the WEE driving unit is configured to move the WEE unit in a radial direction of the wafer.
